(19) United States
(12) Patent Application Publication
(10) Pub. No.: US 2002/0033753 A1
(43) Pub. Date: Mar. 21, 2002

(54) System for prompting user activities

(76) Inventor: Sally Imbo, Weston, CT (US)

Correspondence Address: CUMMINGS & LOCKWOOD, Four Stamford Plaza, P.O. Box 120, Stamford, CT, 06904-0120, US

(21) Appl. No.: 09/894,038

(22) Filed: Jun. 28, 2001

Related U.S. Application Data
(60) Provisional application No. 60/214,406, filed on Jun. 28, 2000.

(51) Int. Cl. H04Q 1/30

(52) U.S. Cl. 340/7.48

(57) ABSTRACT

The present disclosure provides a method/system for facilitating and/or prompting actions on the part of a user. The disclosed method/system utilizes a computer network to communicate with user(s) on a periodic basis to prompt action(s) and the user communicates via the computer network as to responsive action(s) taken. In a preferred embodiment, subsequent prompted action(s) reflect and/or build upon a user's prior action(s) based upon predetermined parameter(s) and/or criteria. The disclosed method/system may be used to promote and/or enhance a user's health fitness and nutrition, and other aspects of the user's life. Personalized information is solicited from the user, and is used to guide the prompts subsequently transmitted to the user. Action menus are provided from which a user may select desired areas of concentration, and the disclosed system/method generally forecloses the possibility that the user will select inappropriate or unhealthy activities based on attributes/limitations of that individual.

### CROSS-REFERENCE TO RELATED APPLICATIONS

The present application claims the benefit of a co-pending provisional patent application entitled “System for Prompting User Activities,” filed on Jun. 28, 2000, and assigned Ser. No. 60/214,406, the entire contents of which are hereby incorporated by reference.

### BACKGROUND

1. Technical Field

The present disclosure relates to a method/system for facilitating and/or prompting actions on the part of a method/system user. More particularly, the present disclosure provides a method/system wherein a computer network is utilized to communicate with user(s) on a periodic basis to prompt action(s) and the user communicates via the computer network as to responsive action(s) taken. In a preferred embodiment, subsequent prompted action(s) reflect and/or build upon a user's prior action(s) based upon predetermined parameter(s) and/or criteria.

2. Background of the Disclosure

The widespread adoption and acceptance of electronic mail systems and the Internet/World Wide Web are profoundly affecting the behavior of individuals and significantly expanding opportunities for improved communications. For example, many Web sites seek to have users register in connection with use thereof. Based on this registration process, Web sites routinely solicit e-mail addresses for registrants and permission to communicate future information/opportunities to such registrants by e-mail. Thus, registrants routinely receive periodic e-mails with information concerning promotions, purchasing opportunities, enhanced services, news updates and the like.

A host of additional communication modalities have arisen in response to the expanded computer infrastructure associated with the Internet/World Wide Web. For example, chat rooms, message boards and mailing lists facilitate communications between users having common areas of interest. For example, individuals routinely utilize such forums to communicate/exchange views concerning investments (e.g., individual stocks, funds, etc.), hobbies, political issues, sports-related topics, and the like. Similarly, software products such as Lotus Notes permit individuals to communicate concerning a project/issue of shared interest, while precluding access by interlopers.

A plethora of information on virtually any topic is also readily available over the Internet/World Wide Web. Informational sites provide both current and historical content and, through hyperlink technology, allow users to readily “surf” from site to site in pursuit of understanding and knowledge. For example, the topics of health, wellness and fitness are extremely well supported with information as is evident based on a recent Jupiter Research Report indicating that more than 1.5 million Web pages currently relate to such topics. In addition, the Web portal Yahoo lists more than 25,000 health and wellness related sites on its search engine. The continued need for improved health and wellness awareness and practices is increasingly evident as scientists point to the role of “nurture” over “nature” in determining the lifespan and quality of human life. Moreover, additional findings and insight flowing from the recent successful mapping of the human genome will open significant opportunities for improved health and wellness.

Nonetheless, the challenges associated with health/wellness are daunting, particularly given the significant obstacles that prevent individuals from finding the time and exercising the discipline necessary to positively influence health/wellness issues. According to a recent CNN report, 45 million American workers spend an average of 6.5 hours each day in front of a computer. In a November 1999 report released by the Occupational Safety and Health Administration, new standards for worker safety lean heavily on corporations to provide adequate information and administrative systems that help employees avoid repetitive strain injuries and lead healthier lives. The average overweight worker costs a company $400 per year in insurance and time lost, and the average smoker costs $960 per year. In 1997, only 15% of adults performed the recommended amount of physical activity and 40% engaged in no leisure time physical activity. These factors and work-related injuries account for more than $60 billion per year in lost time and worker's compensation costs.

Beyond health/wellness issues, there are countless behavioral issues that shape an individual's daily life. For example, individuals are forever wishing to improve/enhance their achievements in a wide range of personal, professional and spiritual arenas, including ongoing desires to stay in touch with friends/relatives, excel in sports through personalized and/or progressive training, achieve investment and savings objectives, address maintenance and repair issues, achieve education and literacy objectives, monitor personal preventative medicine measures more closely, etc. The explosion in “self-help” books demonstrates the general public's continued desire to find a way to achieve its unmet objectives.

Based on the foregoing, a system/method that facilitates an individual's ability to achieve his/her objectives is needed and would likely meet with tremendous success and adoption.

### SUMMARY OF THE DISCLOSURE

The present disclosure provides a method/system that facilitates an individual's ability to achieve his/her objectives, e.g., objectives related to a wide range of personal, professional and spiritual arenas, including ongoing desires to stay in touch with friends/relatives, excel in sports through personalized and/or progressive training, achieve investment and savings objectives, address maintenance and repair issues, achieve education and literacy objectives, monitor personal preventative medicine measures more closely, and the like. In a preferred embodiment of the present disclosure, a method/system is provided that facilitates an individual's ability to achieve his/her health fitness and/or nutritional objectives. According to preferred embodiments of the present disclosure, a computer network is utilized to communicate with user(s) on a periodic basis to prompt desired action(s). In response to such communications, the user communicates via the computer network as to responsive action(s) taken. In a preferred embodiment, subsequent prompted action(s) reflect and/or build upon a user's prior action(s) based upon predetermined parameter(s) and/or criteria.

### BRIEF DESCRIPTION OF FIGURE(S)

So that those of ordinary skill in the art to which the subject matter of the present disclosure appertains will more readily understand how to construct and use the method/system of the present disclosure, reference may be had to the following figures and the accompanying detailed description, wherein:

FIG. 1 is a schematic depiction of an exemplary registration form for use according to the method/system of the present disclosure;

FIG. 2 is an exemplary screen shot of a “Home Page” according to a preferred embodiment of the present disclosure;

FIGS. 3a and 3b are exemplary e-mail messages to a new user of a preferred embodiment of the present disclosure;

FIG. 4 is an exemplary exercise prompt according to the present disclosure;

FIGS. 5 and 6 are exemplary Exercise Page screens showing exemplary exercises according to a preferred embodiment of the present disclosure;

FIG. 7 is an exemplary My Exercises screen showing a portion of a user's exercises according to a preferred embodiment of the present disclosure;

FIG. 8 is an exemplary My Records screen showing a user's activities according to a preferred embodiment of the present disclosure;

FIG. 9 is an exemplary My Settings screen showing a portion of a user's contact information and related data in connection with a preferred embodiment of the present disclosure; and

FIGS. 10a to 10h are exemplary Membership Signup screens according to a further preferred embodiment of the present disclosure.

### DETAILED DESCRIPTION OF PREFERRED EMBODIMENT(S)

According to the present disclosure, a method/system is provided wherein a computer network is utilized to communicate with user(s) on a periodic basis to prompt action(s). The user advantageously communicates via the computer network as to responsive action(s) taken. In a preferred embodiment, subsequent prompted action(s) reflect and/or build upon a user's prior action(s) based upon predetermined parameter(s) and/or criteria. In a further preferred embodiment, a user is provided access, e.g., through downloaded software/program(s) and/or linked Web pages, to textual, video, audio and/or other multimedia content related to the prompted action(s), e.g., tutorial and/or inspirational information and/or content. Thus, the method/system of the present disclosure advantageously inspires, motivates and/or informs users on a periodic basis, e.g., throughout the day, of beneficial actions that might be undertaken by such user.

Although a preferred embodiment of the present disclosure relates to health fitness/wellness-related communications, the method/system of the present disclosure is contemplated for widespread communicative applications, e.g., applications wherein individuals desire to improve/enhance their achievements in a wide range of personal, professional and spiritual arenas. Exemplary applications wherein the system/method of the present disclosure may be advantageously utilized include ongoing desires to undertake sport-specific training, stay in touch with friends/relatives, achieve investment and savings objectives, address maintenance and repair issues, achieve education and literacy objectives, undertake personal preventative medical measures, etc. As will be readily apparent to persons skilled in the art based on the disclosure herein, additional applications may advantageously utilize the system/method disclosed herein.

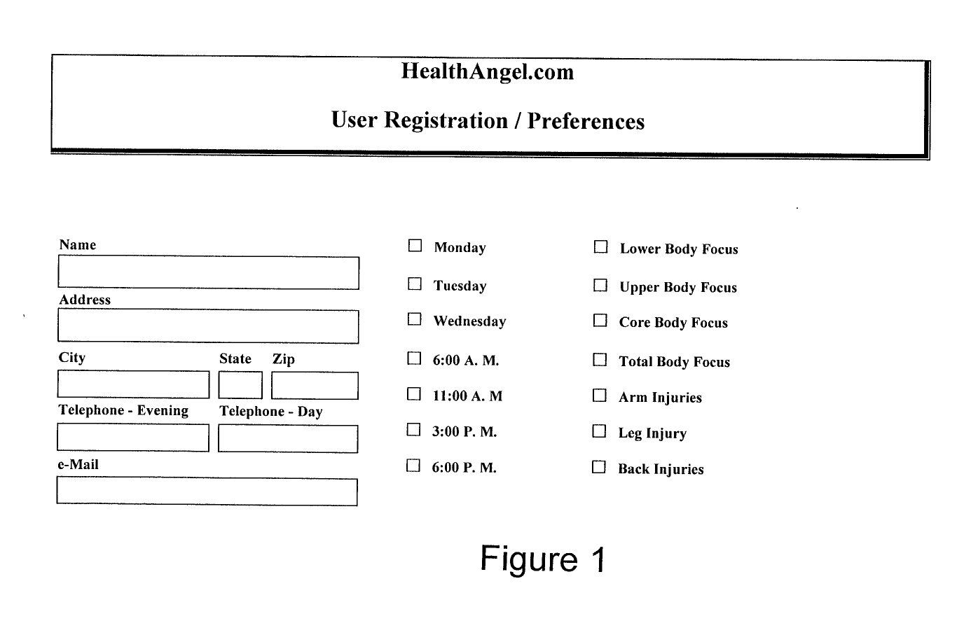

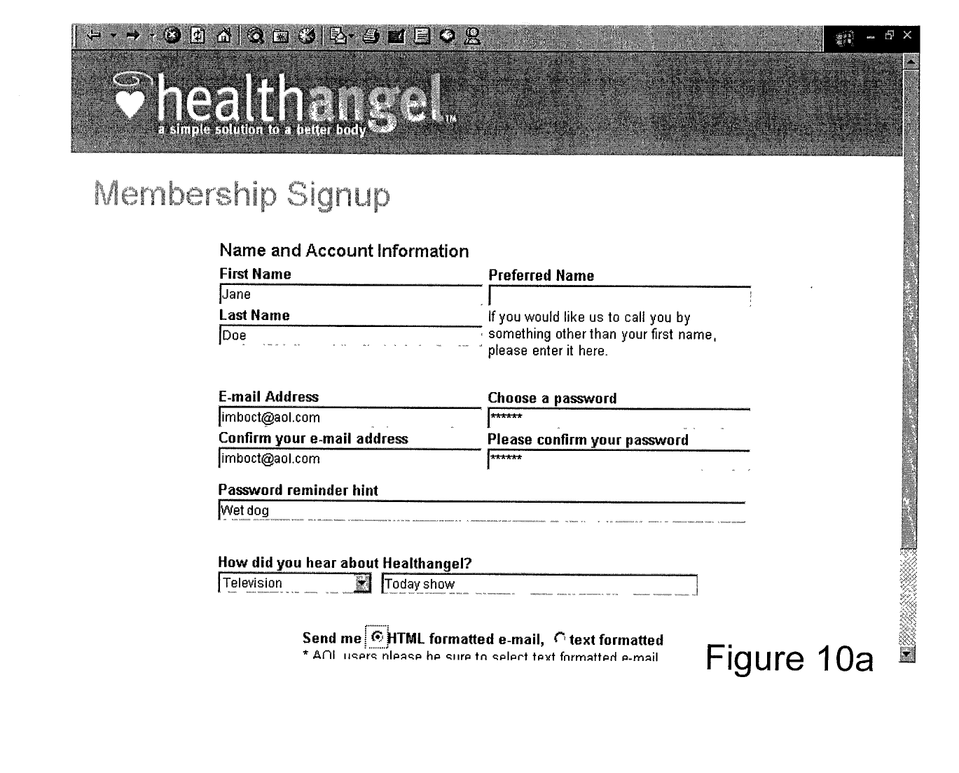

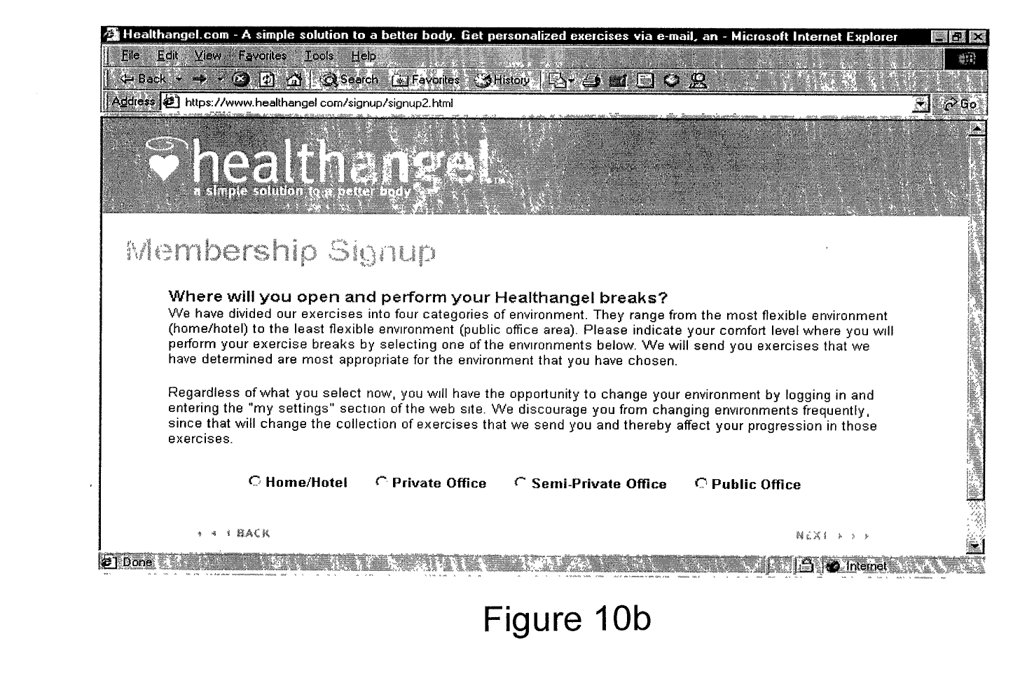

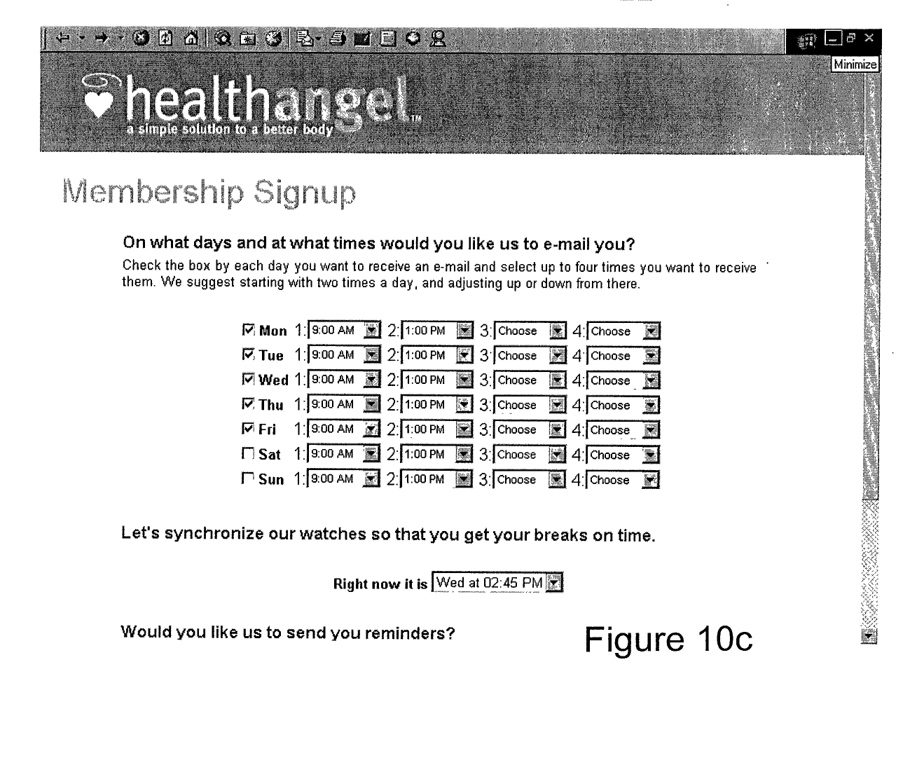

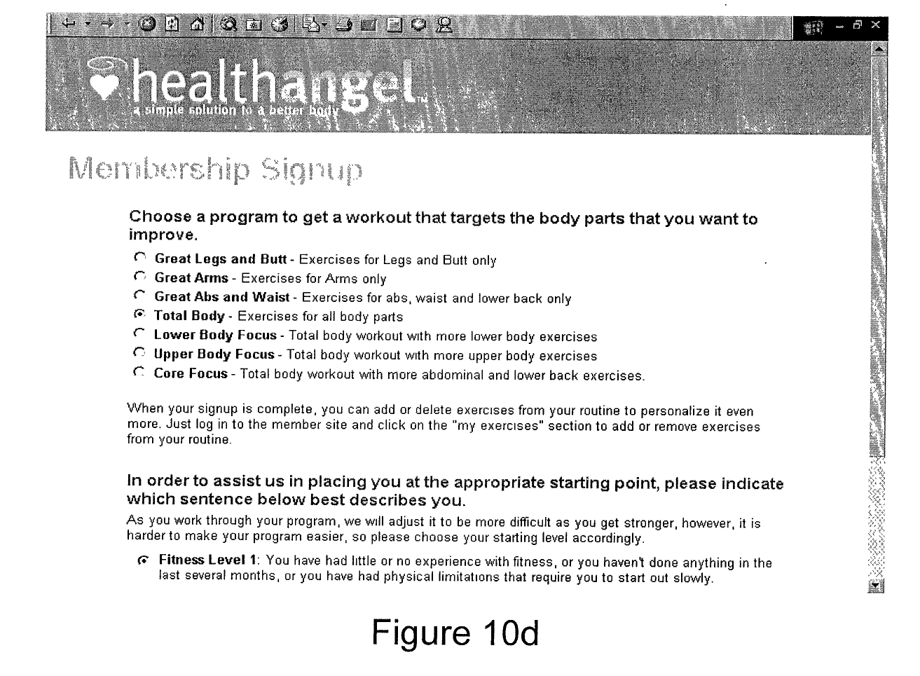

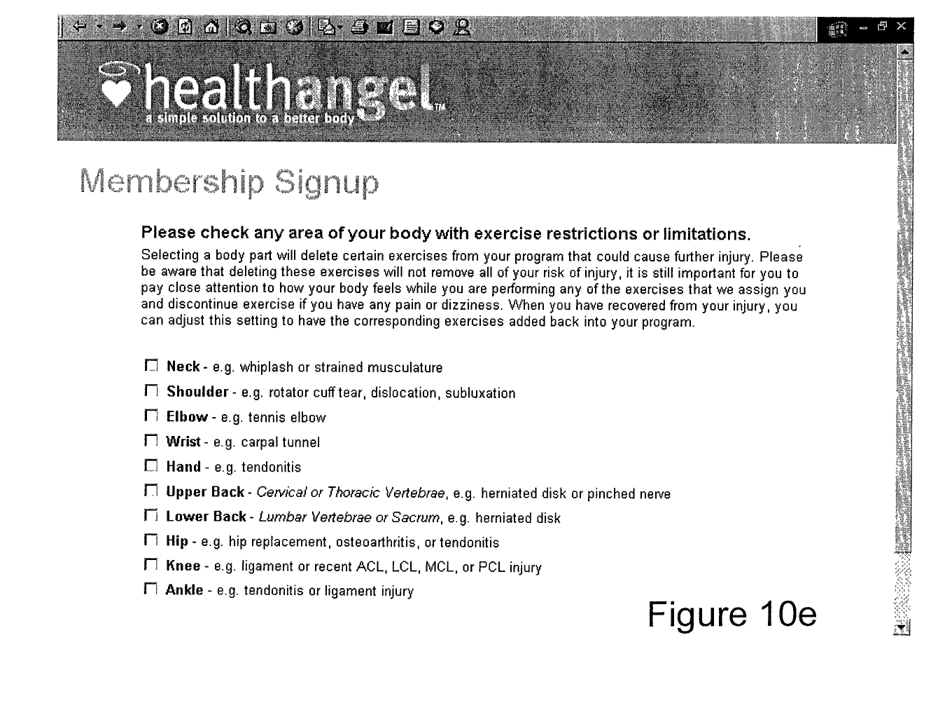

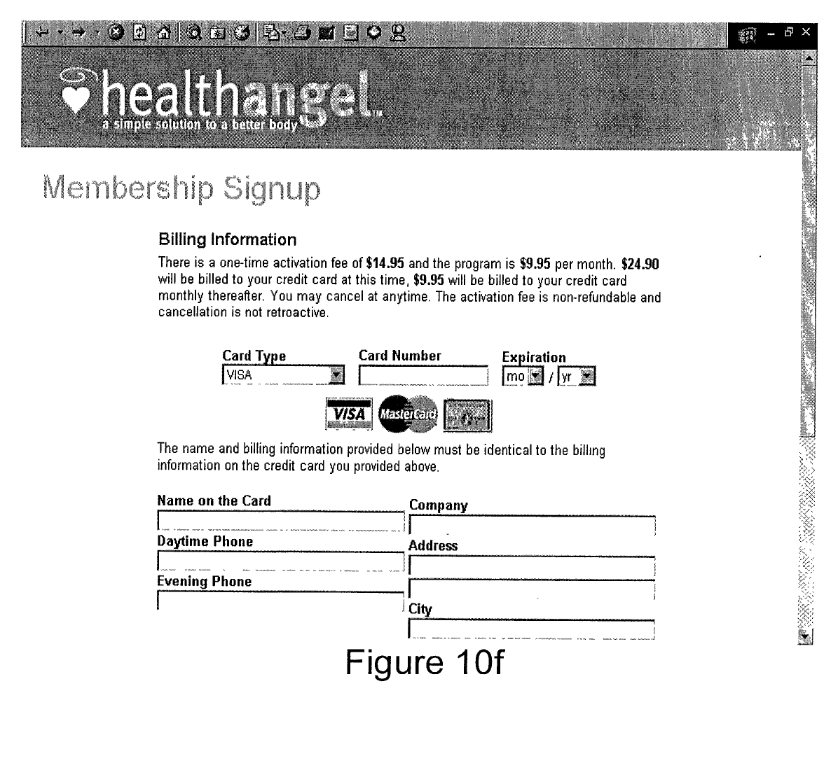

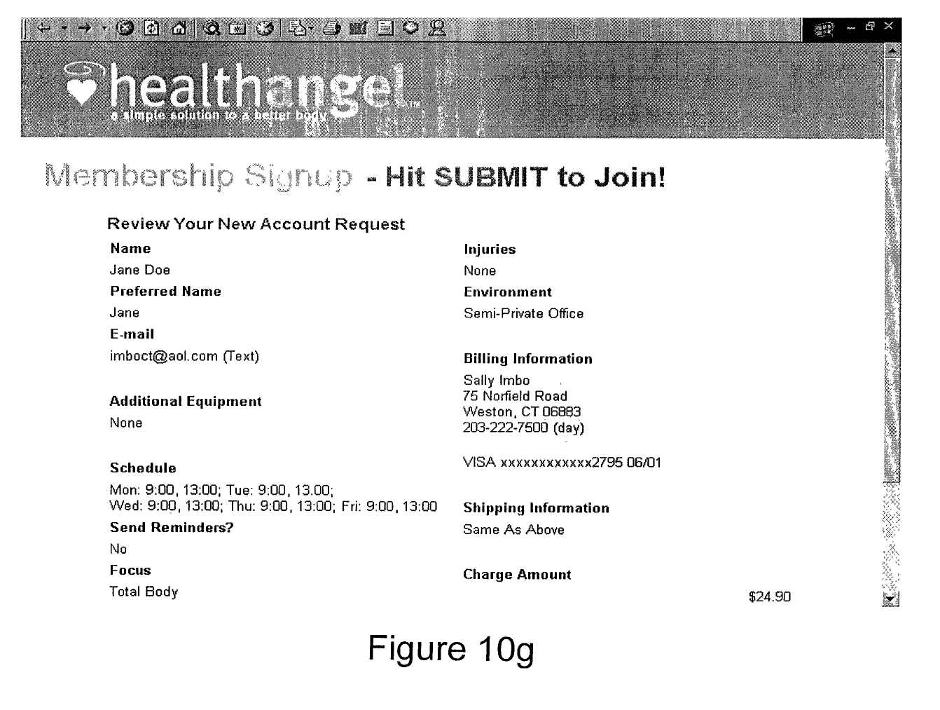

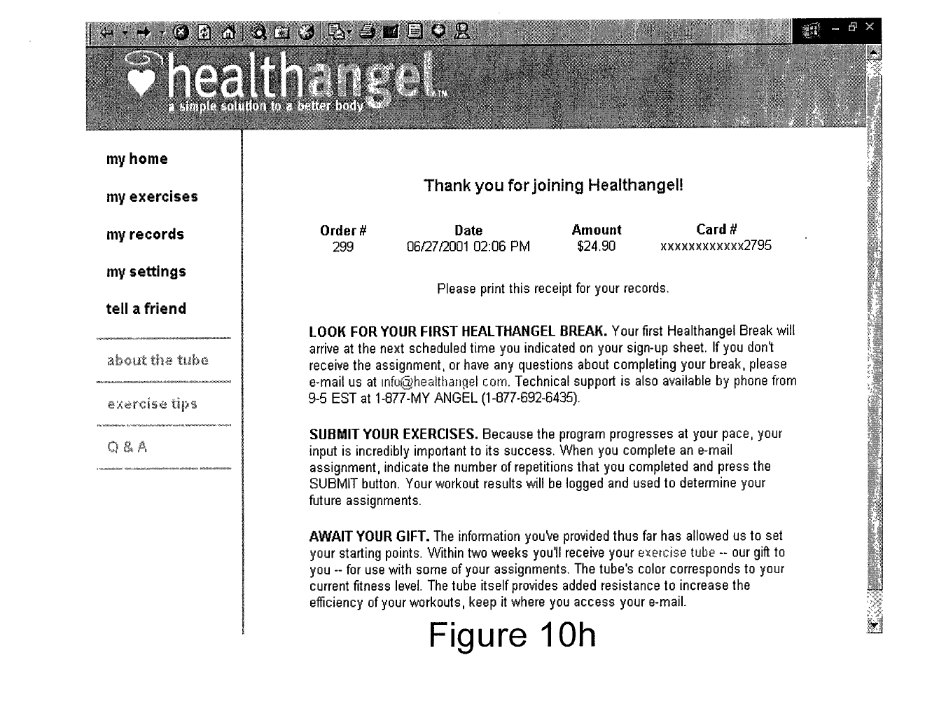

An exemplary system/method according to the present disclosure is described herein, wherein user(s) are prompted on a periodic basis to undertake steps related to health fitness/wellness. According to the system/method, a user/registrant is provided an opportunity to register for participation, preferably on-line, e.g., at a Web site adapted to facilitate such registration. FIG. 1 depicts an exemplary registration form according to the present disclosure, wherein typical user information is solicited, e.g., name, address, phone, etc., and a registrant's e-mail address is solicited, for reasons that will become apparent hereinbelow. An alternative preferred series of Membership SignUp screens are depicted in FIGS. 10a-10h and are discussed hereinbelow.

Beyond the personal identification information requested in the registration form of FIG. 1, a user is solicited to provide certain health fitness objectives (e.g., lower body focus, upper body focus, etc.), work environment (e.g., public office, private office, home, restaurant, etc.), and physical limitations/restrictions (e.g., arm injuries, leg injuries, etc.). As will be readily apparent, the health fitness information solicited in the registration form of FIG. 1 is merely illustrative. Additional information may be sought, e.g., weight, height, age, base-line physical and/or cardiovascular information (e.g., cholesterol level, body fat, blood pressure, etc.), and health fitness habits. Thus, the registration form advantageously obtains certain personalized information that may be useful in assessing the health fitness of the registrant, relevant objectives and limitations, and contact information.

As further illustrated in the exemplary registration form of FIG. 1, a registrant's preferred time(s) for exercise notification are solicited, e.g., day of the week, time of the day, and frequency. Thus, the registrant is permitted to identify and/or specify the desired times for exercise. As will be readily apparent, such “availability/convenience/frequency” information may have relevance to other applications of the system/method of the present disclosure, e.g., communicating with friends/relatives, scheduling time(s) for sports training and/or health fitness activities, pursuing knowledge/literacy, monitoring preventative healthcare appointments, etc. The registration form may also provide for password selection, payment information (e.g., credit card information) and the like.

A User Profile may be advantageously employed to collect additional relevant information concerning a registrant for use in formulating an appropriate/advantageous exercise regimen. An exemplary User Profile is set forth herinebelow, and the additional information set forth in the exemplary User Profile is merely illustrative. The information solicited and/or obtained by way of the exemplary User Profile may be augmented, revised and/or restructured, as will be readily apparent to persons skilled in the art.

Exemplary User Profile:

### User Profile

Please enter your E-mail Address:______

Please enter your first name (how you would like us to refer to you):______

What days of the week would you like to participate in the program?

You may select from 1 to 7 days per week.

| | | | | |
|---|---|---|---|---|
| Monday | Tuesday | Wednesday | Thursday | Friday |
| Saturday | Sunday | | | |

At what times during the day would you like us to e-mail you?

Most users start with two or three times per day, and adjust up or down from there.

Morning

Afternoon

Evening

Late night/Early morning

What state are you in?

We need this information to determine what time it is where you are so that we can email you at the times you requested.

| | | |
|---|---|---|
| Pacific | Central/Mountain | Eastern |

Where will you generally be opening and doing your exercises? (You will have the option of changing your location when you retrieve your exercise each day, just tell us where you will be most often.)

i. Home, hotel (private with room to move)

ii. Private Office (privacy, but restrictive clothing and limited area)

iii. Semi-private office (cubicle or shared office, restrictive clothing)

iv. Public office area (Highly visible work area, Restrictive clothing)

v. Plane, train (Can stand, but don't have lots of room to move)

Are you interested in accessing your exercises via means other than your desktop computer? Please select any that apply.

| | | | |
|---|---|---|---|
| Cell phone | Palm Pilot | Laptop computer | Other device |

What is your current fitness level? (A quick “max test” is contemplated to set starting fitness levels for users)

Beginner

Intermediate

Advanced

Please click on the figure below to indicate any areas of your body where you have chronic exercise restrictions or limitations:

i. Neck

ii. Shoulders

iii. Upper arms

iv. Elbows

v. Forearms

vi. Hands

vii. Upper back

viii. Lower Back

ix. Abs

x. Hips

xi. Quads

xii. Knees

xiii. Calves

xiv. Ankles

xv. Feet

What are your goals for doing this program?

Increase my movement

Reduce my risk of injury

Make time in my busy day for more activity

Increase my level of interest in my own wellness

Be more conscious of my physical self

Work up to a more complete fitness program

Increase my energy level

Get back on the right track after letting my fitness slip

have an event that I'm trying to get into shape for

Disclaimer:

The program is not meant to be a substitute for a traditional exercise program or for the advice of a physician or personal trainer. This program is merely an introduction to fitness that aims to encourage you to think about fitness and increase your activity level moderately and gradually. If you have any reason to believe that increasing your activity level may increase your risk for injury, please contact your physician before starting this or any fitness program.

I have read this disclaimer and will not hold the provider liable for anything that may happen to me as a result of participating in this program.

I have read the above statement and agree.

I do not agree to the above statement.

Once a registrant has completed a registration form, the system/method of the present disclosure advantageously records such information in a database, as is known in the art. Based on the health fitness information obtained from the registrant, including relevant objectives and limitations, the system/method of the present disclosure advantageously creates a personalized health fitness regimen for the registrant. A series of predetermined health fitness programs are programmed into the system/method of the present disclosure from which a personalized workout regimen may be extracted/built for periodic communication to registrants based on predetermined parameters/criteria. Exemplary health fitness programs that may be advantageously programmed into the system/method of the present disclosure are illustrated hereinbelow:

Semi-Private Office/Upper Body Focus
Twice per day, Monday thru Friday, Beginner

| | |
|---|---|
| Monday | Pushup Desk-1 set of 8 (U Compound Upper Body) |
| | Standing or Seated Abduction-1 set of 8 (L Outer Thigh) |
| Tuesday | Praying Mantis Chest Press-1 set of 8 (U Chest) |
| | Isometric Crunch-1 set of 10 (C Abs) |
| Wednesday | Shoulder shrug-1 set of 8 (U Upper Back) |
| | Seated Leg Adduction with tube-1 set of 8 (L Inner Thigh) |
| Thursday | Arm Circles-1 set of 8 (U Shoulders) |
| | Seated lower back-1 set of 8 (C Lower Back) |
| Friday | Seated Overhead Extension with tube-1 set of 8 (U Triceps) |
| | Standing Leg Curl-1 set of 8 (L Hamstrings) |
| Monday | Seated Biceps Curl-1 set of 8 (U Biceps) |
| | Isometric Crunch-1 set of 10) (C Abs) |
| Tuesday | Wrist Extension-1 set of 8) (U Forearms/hands) |
| | Seated Leg Extension-1 set of 8 (L Quadriceps) |
| Wednesday | Push-up Desk-1 set of 8 (U Compound Upper Body) |
| | Seated Lower Back-1 set of 8 (C Lower Back) |
| Thursday | Praying Mantis Chest Press-1 set of 8 (U Chest) |
| | Seated Heel Up, Heels Together-1 set of 8 (L Calf) |
| Friday | Seated Row w/tube-1-set of 8 (U Upper Back) |
| | Isometric crunch-1 set of 10 (C Abs) |
| Monday | Arm Circles-1 set of 8 (U Shoulders) |
| | Chair Squat-1 set of 8 (L Compound Lower Body) |
| Tuesday | Chair dip-1 set of 8 (U Triceps) |
| | Seated Lower Back-1 set of 8 (C Lower Back) |
| Wednesday | Seated Hammer Curls-1 set of 8 (U Biceps) |
| | Standing Hip Extension-1 set of 8 (L Butt) |
| Thursday | Ball Squeeze-1 set of 8 (U Forearms/hands) |
| | Isometric Crunch-1 set of 15 (C Abs) |
| Friday | Pushup Desk-1 set of 8 (U Compound Upper Body) |
| | Standing or Seated Abduction-1 set of 8 (L Outer Thigh) |
| Monday | Praying Mantis Chest Press-1 set of 8 (U Chest) |
| | Seated Lower Back-1 set of 10 (C Lower Back) |
| Tuesday | Shoulder Shrug-1 set of 8 (U Upper Back) |
| | Seated Leg Adduction with Tube-1 set of 8 (L Inner Thigh) |
| Wednesday | Arm Circles-1 set of 8 (U Shoulders) |
| | Isometric Crunch-1 set of 15 (C Abs) |
| Thursday | Seated Overhead Extension with Tube-1 set of 8 |
| | (U Triceps) |
| | Standing Leg Curl-1 set of 8 (L Hamstrings) |
| Friday | Seated Biceps Curl-1 set of 8 (U Biceps) |
| | Seated Lower Back-1 set of 10 (C Lower Back) |
| Monday | Wrist Flexion-1 set of 8 (U Forearms/hands) |
| | Seated Leg Extension-1 set of 8 (L Quadriceps) |
| Tuesday | Pushup Desk-1 set of 10 (U Compound Upper Body) |
| | Isometric Crunch-1 set of 15 (C Abs) |
| Wednesday | Praying Mantis Chest Press-1 set of 10 (U Chest) |
| | Seated Heel Up, Heels Apart-1 set of 8 (L Calf) |
| Thursday | Seated Row-1 set of 8 (U Upper Back) |
| | Seated Lower Back-1 set of 10 (C Lower Back) |

Of note, each of the exercises in the above-identified Semi-Private Office exercise regimen is assigned a code of either “U”, “L” or “C” which correspond to “upper body,” “lower body,” and “core,” respectively. The coding of the various exercises permits an algorithmic selection of exercises according to a predetermined sequencing, e.g., U-L-U-C-U-L-U-C. In a currently preferred sequence for an upper body focus, exercises are sequenced as follows: U-L-U-U-C-U-L-U-L-U-C. Alternative sequences are contemplated, based on the desired mix of upper body, lower body and core exercises, as will be apparent to persons skilled in the art.

According to preferred progressions according to the present disclosure, users advance through the disclosed method/system in a generally uniform pattern. Thus, even though starting members will begin at different points in the progression of a particular exercise, e.g., based on their being at Level 1, Level 2 or Level 3, each member will progress along the exercise patterns outlined herein. Special considerations are generally made according to the disclosed method/system when a user indicates that an exercise is too easy. In such circumstance, the system administrator and/or customer service representative typically advances the user within the exercise progression. Members are typically on a “quick advance” pattern when they begin each exercise, and such members are bumped to the next assignment upon each successful completion. However, when the member can no longer complete the exercise successfully, the rate at which they are advanced is reduced to a “slow advance” pace. The slow advance generally requires three consecutive successful exercise completions in order to advance to the next assignment. This preferred approach offers a high level of personalization to users of the disclosed method/system; indeed, such service level is similar to, and rivals, the service provided by a personal trainer in progressing an individual through exercise assignments to develop strength or build muscle.

### Progression for Home & Hotel-upper Body

Upper Body:

1. Compound (Alternate Pushup with Door Jamb Press)

i. (Beginner) Pushup Desk (1×8, 1×10, 1×12, 1×15, 1×18, 1×20, 2×12, 2×15, 2×18, 2×20, 3×12, 3×15, 3×18, 3×20)

ii. (Intermediate) Pushup Knees (1×8, 1×10, 1×12, 1×15, 1×18, 1×20, 2×12, 2×15, 2×18, 2×20, 3×12, 3×15, 3×18, 3×20)

iii. (Advanced) Pushup Toes (1×8, 1×10, 1×12, 1×15, 1×18, 1×20, 2×12, 2×15, 2×18, 2×20, 3×12, 3×15, 3×18, 3×20)

iv. (Beg-Adv.) Door Jamb Press (1×8, 1×10, 1×12, 1×15, 1×18, 1×20, 2×12, 2×15, 2×18, 2×20, 3×12, 3×15, 3×18, 3×20)

2. Chest

i. (Beginner) (Praying Mantis Chest Press with Tube (1×8, 1×10, 1×12, 1×15, 1×18, 1×20, 2×12, 2×15, 2×18, 2×20, 3×12, 3×15, 3×18, 3×20)

ii. (Int.-Adv.) Alternate Chest Press and Chest Fly (dumbbell or tube) (1×8, 1×10, 1×12, 1×15, 1×18, 1×20, 2×12, 2×15, 2×18, 2×20, 3×12, 3×15, 3×18, 3×20)

3. Upper Back (Alternate between i. and ii.—Beginning with no weight, then advance to dumbbells or tube)

i. Shoulder Shrug (1×8, 1×10, 1×12, 1×15, 1×8, 1×20, 2×12, 2×15, 2×18, 2×20, 3×12, 3×15, 3×18, 3×20)

ii. Alternate Seated Row and Bent Over Row (1×8, 1×10, 1×12, 1×15, 1×18, 1×20, 2×12, 2×15, 2×18, 2×20, 3×12, 3×15, 3×18, 3×20)

4. Shoulders (Beginner does arm circles, then alternate ii. All these are standing for Home and Hotel)

i. (Beg.-Int.) Arm Circle (1×8, 1×10, 1×12, 1×15, 1×18, 1×20, 2×12, 2×15, 2×18, 2×20, 3×12, 3×15, 3×18, 3×20)

ii. (Beg.-Adv.) Alternate Overhead Shoulder Press, Lateral Raise, Upright Row, Frontal Raise (1×8, 1×10, 1×12, 1×15, 1×18, 1×20, 2×12, 2×15, 2×18, 2×20, 3×12, 3×15, 3×18, 3×20)

5. Triceps (Rotate i. With ii.)

i. (Beg.-Int.) Alternate Bent Over Extension and Overhead Extension (both standing) (1×8, 1×10, 1×12, 1×15, 1×18, 1×20, 2×12, 2×15, 2×18, 2×20, 3×12, 3×15, 3×18, 3×20)

ii. (Int.-Adv.) Chair Dip (1×8, 1×10, 1×12, 1×15, 1×18, 1×20, 2×12, 2×15, 2×18, 2×20, 3×12, 3×15, 3×18, 3×20)

6. Biceps

i. Alternate Biceps Curl Standing with Hammer Curls Standing (incorporate progression of resistance tube or dumbbells) (1×8, 1×10, 1×12, 1×15, 1×18, 1×20, 2×12, 2×15, 2×18, 2×20, 3×12, 3×15, 3×18, 3×20)

7. Forearms/Hands (Alternate all three)

i. Wrist Extension (1×8, 1×10, 1×12, 1×15, 1×18, 1×20, 2×12, 2×15, 2×18, 2×20, 3×12, 3×15, 3×18, 3×20)

ii. Wrist Flexion (1×8, 1×10, 1×12, 1×15, 1×18, 1×20, 2×12, 2×15, 2×18, 2×20, 3×12, 3×15, 3×18, 3×20)

iii. Ball Squeeze (1×8, 1×10, 1×12, 1×15, 1×18, 1×20, 2×12, 2×15, 2×18, 2×20, 3×12, 3×15, 3×18, 3×20)

### Progression for Home & Hotel—Core

Core Body Exercises:

Abdominal Exercises (Advance from Isometric, to Crunch, to Sit-up)

1. Isometric crunch (beginner) (1×10, 1×15, 1×20, 1×25, 2×15, 2×20, 2×25, 3×20, 3×30, 3×35)

2. Rotate Classic, Reverse, Side (Intermediate) (1×10, 1×15, 1×20, 1×25, 2×15, 2×20, 2×25, 3×20, 3×30, 3×35)

3. Full Sit up (Advanced) (1×10, 1×15, 1×20, 1×25, 2×15, 2×20, 2×25, 3×20, 3×30, 3×35)

Lower Back (Advance from Prone Hyper Side, to Head, to Superman)

1. Prone Hyperextension Arms Side (1×8, 1×10, 1×12, 1×15, 1×18, 1×20, 2×12, 2×15, 2×18, 2×20, 3×12, 3×15)

2. Prone Hyperextension Arms Head (1×8, 1×10, 1×12, 1×15, 1×18, 1×20, 2×12, 2×15, 2×18, 2×20, 3×12, 3×15, 3×18, 3×20)

3. Superman (1×8, 1×10, 1×12, 2×8, 2×10, 2×12, 3×8, 3×10, 3×12)

### Progression for Home & Hotel Lower Body

1. Compound (Alternate Squat and Lunge):

a. Squat (progress from Beginner Wall Squat to Alternating Squat and Plies Squat to Alternating Dumbbell Squat and Advanced Wall Squat)

i. (Beginner) Beginner Wall squat (1×8, 1×10, 1×12, 1×15)

ii. (Intermediate-Advanced) Alternate Squat and Plies Squat (1×8, 1×10, 1×12, 1×15, 1×18, 1×20, 2×12, 2×15, 2×18, 2×20, 3×12, 3×15, 3×18, 3×20)

iii. (Advanced) Dumbbell squat (1×8, 1×10, 1×12, 1×15, 1×18, 1×20, 2×12, 2×15, 2×18, 2×20, 3×12, 3×15, 3×18, 3×20)

iv. (Advanced) Advanced Wall Squat (hold squat against wall 20 seconds, 35 seconds, 45 seconds, 1 min)

b. Lunge (Progress from Alternating Lunge & Reverse Lunge to Alternating Lunge Pumps, Walking Lunges and Advanced Lunge)

i. (Beginner) Lunge & Reverse Lunge (1×8, 1×10, 1×12, 1×15, 1×18, 1×20, 2×12, 2×15, 2×18, 2×20, 3×12, 3×15, 3×18, 3×20)

ii. (Int./Adv.) Lunge Pumps (1×8, 1×10, 1×12, 1×15, 1×18, 1×20, 2×12, 2×15, 2×18, 2×20, 3×12, 3×15, 3×18, 3×20)

iii. (Int./Adv.) Walking Lunge (10 steps, 20 steps, 30 steps, 40 steps, 50 steps)

iv. (Int./Adv.) Advanced Lunge (hold 10 seconds, hold 15 seconds, hold 20 seconds)

2. Buttocks: Beginner is Standing, Intermediate is alternating Bent Leg Kickbacks, Bent Leg Crosses and Lying Knee Backs, and Advanced is Pelvic Lift and Single Leg Lift.

a. (Beginner) Standing Hip Extension (1×8, 10, 1×12, 1×15, 1×18, 1×20, 2×12, 2×15, 2×18, 2×20, 3×12, 3×15, 3×18, 3×20)

b. (Intermediate) Alternate Bent leg kickbacks on all fours, Bent Leg Crosses and Lying Knee Backs (1×8, 1×10, 1×12, 1×15, 1×18, 1×20, 2×12, 2×15, 2×18, 2×20, 3×12, 3×15, 3×18, 3×20)

c. (Advanced) Alternate Pelvic Lift and Single Leg Lift (1×8, 1×10, 1×12, 1×15, 1×18, 1×20, 2×12, 2×15, 2×18, 2×20, 3×12, 3×15, 3×18, 3×20)

3. Outer Thigh: (Beginner does standing, move to Rotation of Lying and Kneeling, then add tube)

i. (Beginner) Standing Abduction (1×8, 1×10, 1×12, 1×15, 1×18, 1×20, 2×12, 2×15, 2×18, 2×20, 3×12, 3×15, 3×18, 3×20)

ii. (Intermediate) Alternate Lying Outside Leg Raises and Kneeling Side Leg Raises (1×8, 1×10, 1×12, 1×15, 1×18, 1×20, 2×12, 2×15, 2×18, 2×20, 3×12, 3×15, 3×18, 3×20)

iii. (Intermediate) Standing Abduction with Tube (1×8, 1×10, 1×12, 1×15, 1×18, 1×20, 2×12, 2×15, 2×18, 2×20, 3×12, 3×15, 3×18, 3×20)

iv. (Advanced) Alternate Lying Outside Leg Raises with tube and Kneeling Side Leg Raises with Tube (1×8, 1×10, 1×12, 1×15, 1×18, 1×20, 2×12, 2×15, 2×18, 2×20, 3×12, 3×15, 3×18, 3×20)

4. Inner Thigh: (Start with Standing, move to Lying and Butterfly, then add tube)

i. (Beginner-Adv.) Standing Leg Adduction with Tube (1×8, 1×10, 1×12, 1×15, 1×18, 1×20, 2×12, 2×15, 2×18, 2×20, 3×12, 3×15, 3×18, 3×20)

ii. (Beginner) Alternate Lying Leg Raises and Butterfly Raises (1×8, 1×10, 1×12, 1×15, 1×18, 1×20, 2×12, 2×15, 2×8, 2×20, 3×12, 3×15, 3×28, 3×20)

iii. (Int.-Adv.) Alternate Lying Leg Raises with Tube and Butterfly Raises with Tube (1×8, 1×10, 1×12, 1×15, 1×18, 1×20, 2×12, 2×15, 2×18, 2×20, 3×12, 3×15, 3×18, 3×20)

5. Hamstrings: (Beginner starts with Standing Curl, progress to Curl with resistance)

i. (Beginner) Standing Leg Curl (1×8, 1×10, 1×12, 1×15, 1×18, 1×20, 2×12, 2×15, 2×18, 2×20, 3×12, 3×15, 3×18, 3×20)

ii. (Int.-Adv.) Standing Leg Curl with Tube or Dumbbell Curl depending on access to equipment (1×8, 1×10, 1×12, 1×15, 1×18, 1×20, 2×12, 2×15, 2×18, 2×20, 3×12, 3×15, 3×18, 3×20)

6. Quadriceps: Beginner starts without tube (i.) and advances to tube (ii.)

i. (Beginner) Alternate Standing Leg Extension and Front Leg Raises (1×8, 1×10, 1×12, 1×15, 1×18, 1×20, 2×12, 2×15, 2×18, 2×20, 3×12, 3×15, 3×18, 3×20)

ii. (Int.-Adv.) Alternate Standing Leg Ext. with tube and Front leg raises with tube (1×8, 1×10, 1×12, 1×15, 1×18, 1×20, 2×12, 2×15, 2×18, 2×20, 3×12, 3×15, 3×18, 3×20)

7. Calf: Beginner is Seated, Intermediate is Standing

i. (Beg.-Int.) Alternate Heel Up—Seated with Heels Together with Seated Heels Apart (1×8, 1×10, 1×12, 1×15, 1×18, 1×20, 2×12, 2×15, 2×18, 2×20, 3×12, 3×15, 3×18, 3×20)

ii. (Int.-Adv.) Alternate Heel Up Standing—Heels Together and Heels Apart (1×8, 1×10, 1×12, 1×15, 1×18, 1×20, 2×12, 2×15, 2×18, 2×20, 3×12, 3×15, 3×18, 3×20)

In preferred embodiments hereof, the system/method of the present disclosure is adapted to personalize a workout regimen in one or more respects and/or in response to varying types and degrees of user input. For example, a preferred system/method includes programming that deletes and/or modifies a user's pool of exercises (either specific exercises, classes of exercises, or combinations thereof) based upon user input, e.g., the user doesn't like the exercise, finds the exercise inappropriate for his/her surrounding environment, finds the exercise ineffective or aggravating to an existing condition, etc. In addition, a preferred system/method of the present disclosure includes programming that adjusts exercise assignments based on specific strengths/weaknesses of individual users. Thus, a user having a particular strength, e.g., strong biceps, is advantageously prompted to perform assignment(s) that build upon and take advantage of such individual strength. Moreover, the system/method of the present disclosure is optimally adapted to progressively adjust/modify and increase/decrease the exercise recommendations based thereon. Similarly, the exercise regimen developed/selected for a particular user/individual will also be advantageously adjustable, in real time, by the user/individual, e.g., by altering his/her preferences “on the fly.” In this way, periodic changes/issues encountered by a user/individual, e.g. an injury, may be readily accommodated and addressed through a restructured exercise regimen according to the method/system of the present disclosure. As such, the system/method of the present disclosure advantageously becomes increasingly personalized as the registrant/user gives feedback thereto.

With specific reference to the Semi-Private workout regimen with an upper body focus set forth hereinabove, an exemplary set of exercises are illustrated for potential communication to, and use by, a registrant who has elected to exercise “twice per day,” in a semi-private office, with an upper body focus, at a beginner level. Advantageously, the depicted exercises are of a type that they may be undertaken by a registrant without change of clothes and/or travel to a gym/club. Rather, the depicted exercises are of a type that they may be undertaken by an office worker (in a semi-private office setting) during the course of a workday, thereby greatly increasing the likelihood that the user will successfully find the necessary time and motivation. Further exemplary exercise regimens are provided hereinabove that are particularly adapted for use in an exercise progression for home and hotel—upper body focus, for use in an exercise progression for home and hotel—core focus, and for use in an exercise progression for home and hotel—lower body focus. Alternative exercise regimens are contemplated, e.g., for different levels of fitness, for different exercise settings, for different physical ailments and/or objectives, etc. However, the exemplary exercise regimens detailed hereinabove provide illustrative exercise regimens according to the method/system of the present disclosure.

The system/method of the present disclosure advantageously utilizes one or more software programs that advantageously utilize/process the information provided by a registrant to access/identify/select appropriate exercise regimen(s) from a pre-populated database containing exercise regimens like those depicted hereinabove. The software program(s) may be hosted, e.g., utilizing an Application Service Provider (ASP) model, and/or delivered/provided to users for localized operation, e.g., on a wide area network (WAN), a local area network (LAN), or a personal computer. The database advantageously contains one or more exercise regimens for each data combination that may be submitted by a registrant utilizing the registration form (e.g., the exemplary registration form of FIG. 1). To the extent multiple exercise regimens are provided in the pre-populated database for a given data combination, it is contemplated that the software program may select therefrom based on a variety of factors, e.g., on a randomized and/or seriatim basis.

Once an exercise regimen is identified/selected, the system/method of the present disclosure advantageously provides periodic prompts to the registrant to undertake an appropriate exercise. Thus, for example, if the registrant's submitted data resulted in selection of the exercise depicted hereinabove for use in a semi-private office with an upper body focus, on the first Monday of the exercise program and at the registrant's pre-selected time, e.g., 10 a.m., an e-mail prompt or notification would be transmitted to the registrant instructing that the “Desk Pushup—1 set of 8” exercise be performed. In a preferred embodiment of the method/system of the present disclosure, a software-generated icon on a registrant's desktop monitor, e.g., as part of a toolbar, would signal to a registrant the arrival/presence/availability of an exercise prompt. An exemplary e-mail communication is depicted hereinbelow, wherein a hypothetical registrant (“JSmith”) is prompted to perform the desired exercise:

Jsmith@WTGroup.net

Exercise@Healthangel.com

Subject: Healthangel.com

Good Morning John,

Hope that your day is going well. Since your focus of concentration is on your upper body, we are going to start you out working your biceps today.

Biceps Curls: ______ Sets of ______ Repetitions. For details on how to properly do the exercise, click on the link above.

Click here to record this exercise session.

Keep up the great work!

The system/method of the present disclosure is particularly advantageous in that the exercise prompt is automatically communicated to the registrant at his/her desired e-mail location, e.g., his/her office. Provided appropriate coding, as is known in the art, the communications may be picked up remotely, e.g., via Palm Pilot or the like. In addition, as network communication technologies evolve and improve, it will be possible for registrant's to remotely access background information, e.g., tutorial video content, using a portable access device, e.g., a cellular phone and/or a Palm-type device. It is further contemplated that a registrant may easily communicate an alternative e-mail address for periods of travel, e.g., when working as a consultant at client locations or on vacation at a friend's house. Indeed, a registrant's e-mail address generally may be changed at any time, and provided the system/method is hosted for access via the Internet, a registrant may access his/her account and exercises at any time and from any location by logging on and signing in to the site. Thus, the system/method of the present disclosure is advantageously designed to communicate with a transitory registrant.

With further reference to the prompt to “Jsmith@WTGroup.net” set forth hereinabove, a registrant is preferably provided with access to background and/or detailed information concerning recommended exercise(s). According to the present disclosure, it is contemplated that such background/detailed information may be accessible to registrants in one or more ways. In a first embodiment, background/detailed information is advantageously contained on one or more Web pages associated with a Web site maintained according to the present disclosure. Alternatively, background/detailed information concerning recommended exercises may be provided within a program that is optimally downloaded by a registrant, e.g., to the registrant's hard drive or other personal information storage device, for periodic access on an as-needed basis. Detailed/background information may take a variety of multimedia formats, e.g., audiovisual displays of the exercises being performed and/or textual/narrative descriptions thereof.

With further reference to the aforementioned “Jsmith@WTGroup.net” prompt, a hyperlink is preferably provided to the location of the “exercise page” for the recommended exercise. In the event the “exercise page” is contained at an associated Web page, the hyperlink or other direct connection advantageously opens the desired page for registrant viewing. Alternatively, if the “exercise page” is contained in a program that has been downloaded to the registrant's hard drive or other personal information storage device, the registrant will be notified that it is time for an exercise break, e.g., via an “icon” signal on the registrant's monitor, and the registrant may access the desired information, e.g., by clicking on the icon. It is contemplated that clicking on the icon will advantageously initiate operation of such program and, optimally, skip to the applicable segment thereof, as is known in the art. In one embodiment of the present disclosure, a registrant is given a choice as to how such registrant will be notified of exercise breaks and where such registrant may access background/detailed information concerning recommended exercises, e.g., during the registration process. Of note, appropriate accessories that are available for purchase may be highlighted and/or linked on Web pages and/or as part of downloaded program segments related to a recommended exercise.

With further reference to the “Jsmith@WTGroup.net” prompt, a link is preferably provided on the “exercise page” for communicating workout completion to the database associated with the present system/method. An exemplary communication screen that may be advantageously associated with the “exercise page” is provided hereinbelow:

Let us know how you did on your workout.

Workout: #73

Exercise: Biceps Curls

Resistance: Red Resistance Tube

I completed ______ sets of ______ repetitions.

______ I don't have time now, please remind me again in ______ hours.

______ Please take this exercise off of my list, it doesn't work for me.

______ This exercise doesn't work for me today; please send me a different exercise.

[Submit Button]

Thus, a registrant may easily and efficiently communicate his/her completion or non-completion of a recommended exercise to the database. By clicking on the submit button, the communication is automatically transmitted across the network, e.g., via e-mail, the Internet and/or the World Wide Web, for recordation in the database with respect to such registrant. Alternatively, in circumstances where the registrant is utilizing a downloaded version of some or all of the operative software programs associated with the system/method of the present disclosure, communication of his/her completion or non-completion of a recommended exercise may be stored on or with the operative software program, e.g., on a LAN, WAN or personal computer, for transmission across the network to a central database next time the registrant accesses such network, e.g., the Internet.

According to the system/method of the present disclosure, a user can opt-in for follow-up prompts that may be automatically transmitted to a registrant if a response is not received concerning a recommended exercise within a predetermined time. Registrant's who have failed to respond over a longer period of time receive one or more follow-up prompts that are encouraging and/or inspirational in nature. Such follow-up prompts may have a variety of forms and tones, e.g., encouraging, firm, humorous, etc. It is contemplated that the tone of such communications may be randomly selected and/or predicated on certain personality-related information concerning a registrant, e.g., information solicited during the registration process or during the exercise regimen.

Based on a registrant's submission of data detailing the registrant's performance (or non-performance) of recommended exercises, the system/method of the present disclosure advantageously adjusts and/or modifies future recommendations to provide each registrant with personalized health fitness training. Thus, if a registrant is successfully submitting performance data on his/her completed exercises, the system/method of the present disclosure advantageously adjusts the registrant's exercise assignments to continuously set appropriate goals for advancement of the registrant's physical abilities. Conversely, if the registrant is not successfully completing his/her exercise assignment, the system/method may advantageously stall the advancement of the recommended exercises to address such non-performance. Also, if a registrant is not successfully submitting performance data on his/her completed exercises, the system/method will preferably generate communication(s) to the registrant as a reminder and provide a “motivational” message, as appropriate, to encourage further effort on the part of the registrant. In addition, it is contemplated that a registrant may be prompted to provide input concerning his/her enjoyment and/or preference for various types of exercises so that adjustments to the exercise program may be made over time.

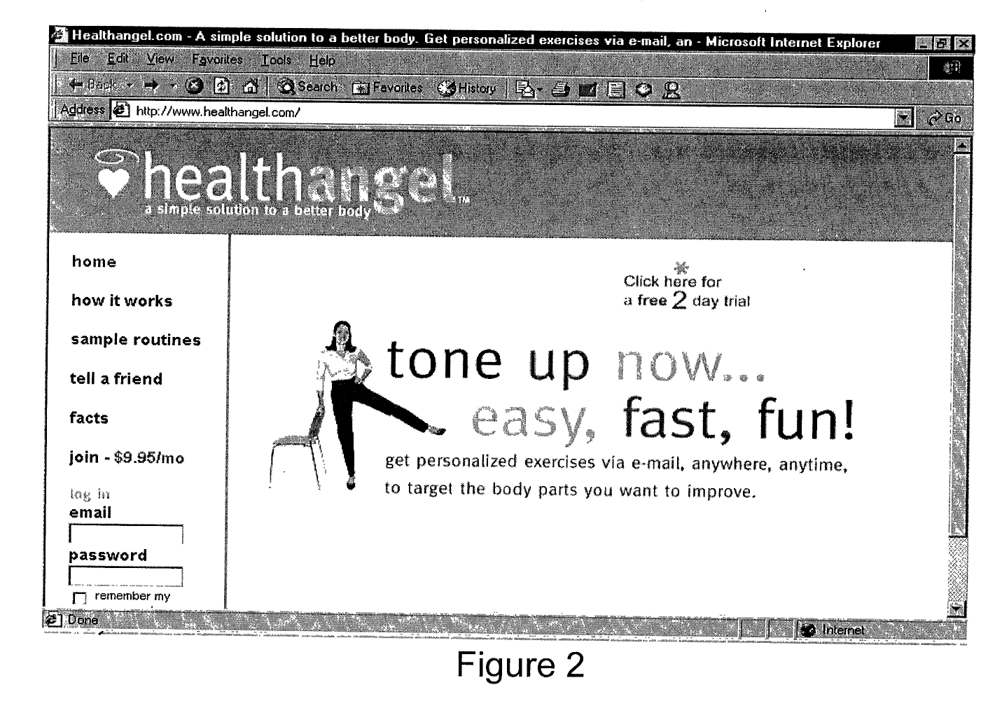

With reference to FIG. 2, an exemplary “Home Page” screen shot is depicted for a Web site according to a preferred embodiment of the present disclosure. Of note, the depicted Home Page includes “log in” functionality in the lower left hand corner, pursuant to which a registered user may utilize the functionalities enabled by the Web site (e.g., by entering an email address and a password). The log in functionality operates to validate a Web site user's entries against a database of registered user information, as is known in the art. Alternatively, a new visitor to the exemplary Home Page of FIG. 2 may click the “join” link, or a “free trial” button (if offered), to enter a registration process, as described hereinbelow.

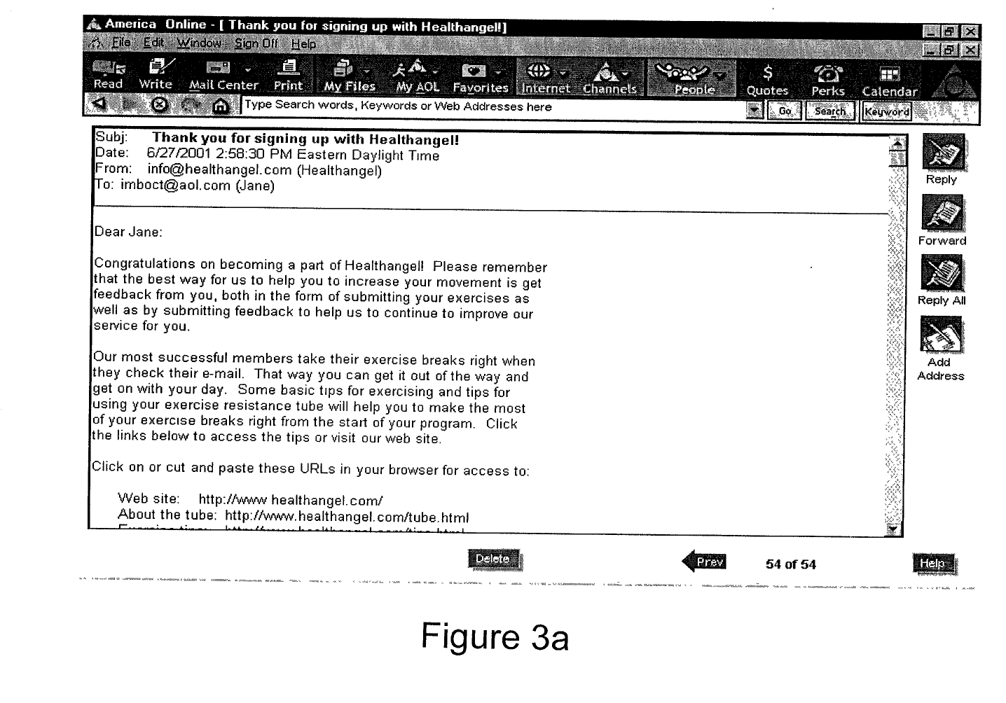

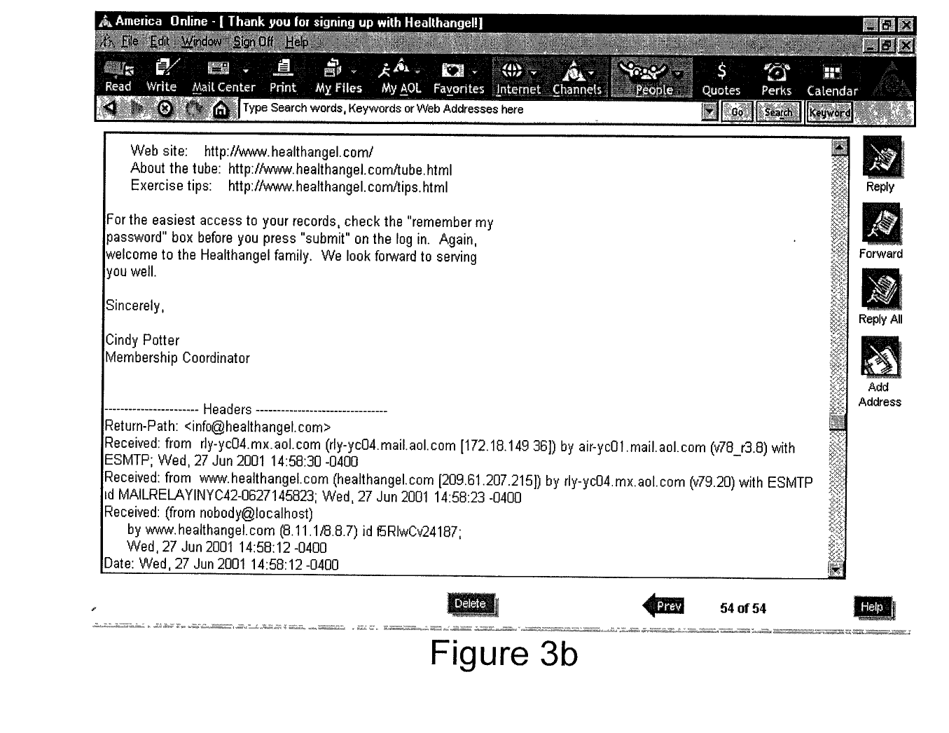

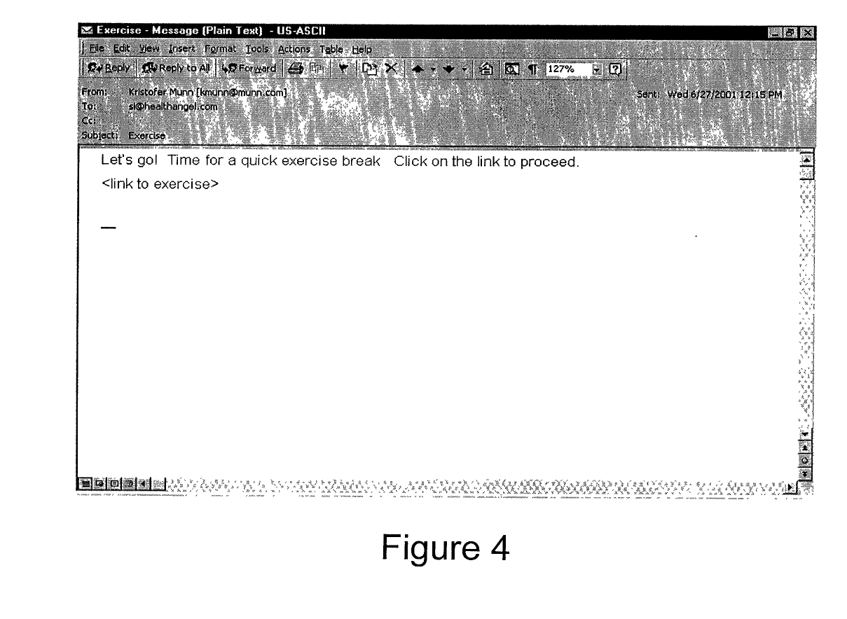

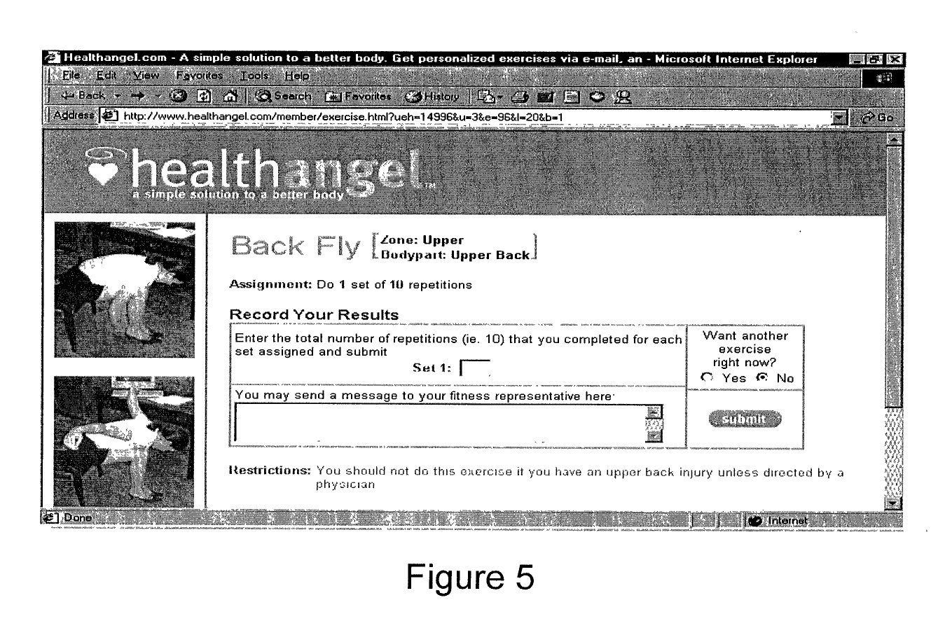

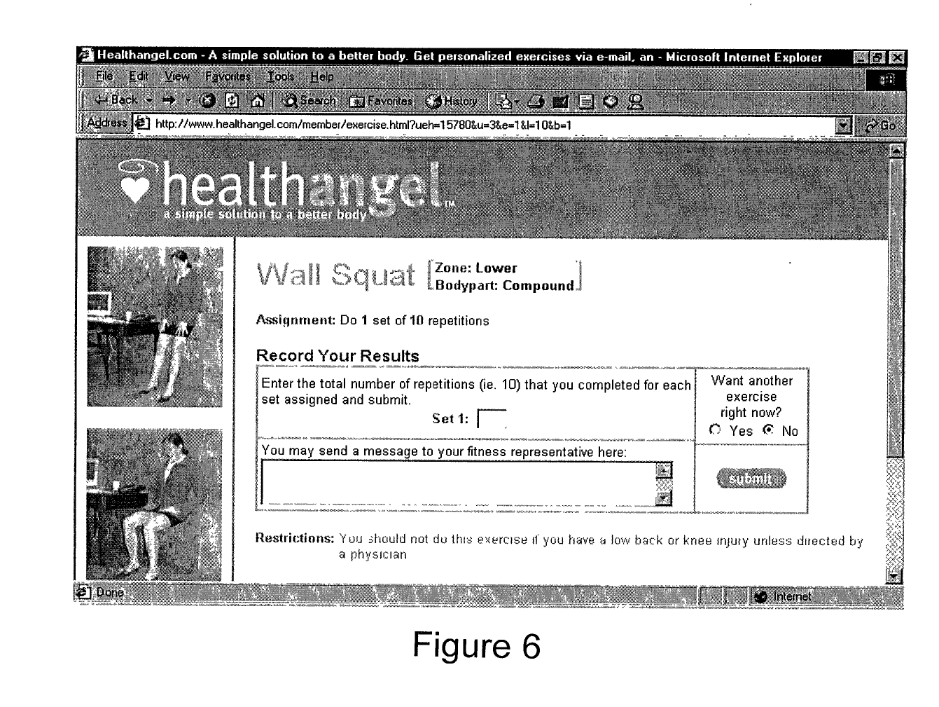

FIGS. 3a and 3b provide an exemplary e-mail message to a newly registered user, welcoming the user to the disclosed method/system and providing additional reference information, e.g., URLs related to operation and use of the disclosed method/system. FIG. 4 provides an exemplary e-mail message to a user prompting an exercise break. As set forth in the exemplary e-mail message of FIG. 4, the user is advantageously provided with a link to an exercise page of the type depicted in FIGS. 5 and 6, such exercises being selected by the method/system based on the personal information for that particular user. As noted hereinbelow, the exercise page generally provides the user with a readily utilized mechanism for responding to the method/system upon completion of the exercise.

FIGS. 5 and 6 are “exercise pages” showing exemplary exercises that a user may be prompted to perform according to the present disclosure. FIG. 5 relates to a “Back Fly” exercise and, as shown in FIG. 5, includes an assignment as to the number of repetitions (“Do 1 set of 10 repetitions”), an identification of the primary body regions that stand to benefit from the exercise (“Zone: Upper; Bodypart: Upper Back”), and appropriate restrictions (“You should not do this exercise if you have an upper back injury unless directed by a physician”). Similarly, FIG. 6 relates to “Wall Squat” exercise and includes an assignment as to the number of repetitions (“Do 1 set of 10 repetitions”), an identification of the primary body regions that stand to benefit from the exercise (“Zone: Lower; Bodypart: Compound”), and appropriate restrictions (“You should not do this exercise if you have low back or knee injury unless directed by a physician”).

For both exercises depicted in FIGS. 5 and 6, the user is provided with an opportunity to communicate his/her completion of the exercise (“Enter the total number of repetitions (ie 10) that you completed for each set assigned and submit”), as well as any comments or questions the user may have (“You may send a message to your fitness representative here”). In addition, the user may communicate his/her desire to receive an additional exercise from the system/method (“Want another exercise right now?”). Finally, the exemplary screen shots depicted in FIGS. 5 and 6 provide photographic instructional materials related to the subject exercises to assist users in performing the exercises in an appropriate manner. Additional narrative instructional material may be provided, if desired. In preferred embodiments of the present disclosure, the exemplary exercises depicted in FIGS. 5 and 6 may be accessed by the user, in response to an email prompt, through a link contained within the email “prompt” forwarded to the user according to the method/system of the present disclosure, or by logging in to the disclosed system, as described hereinabove.

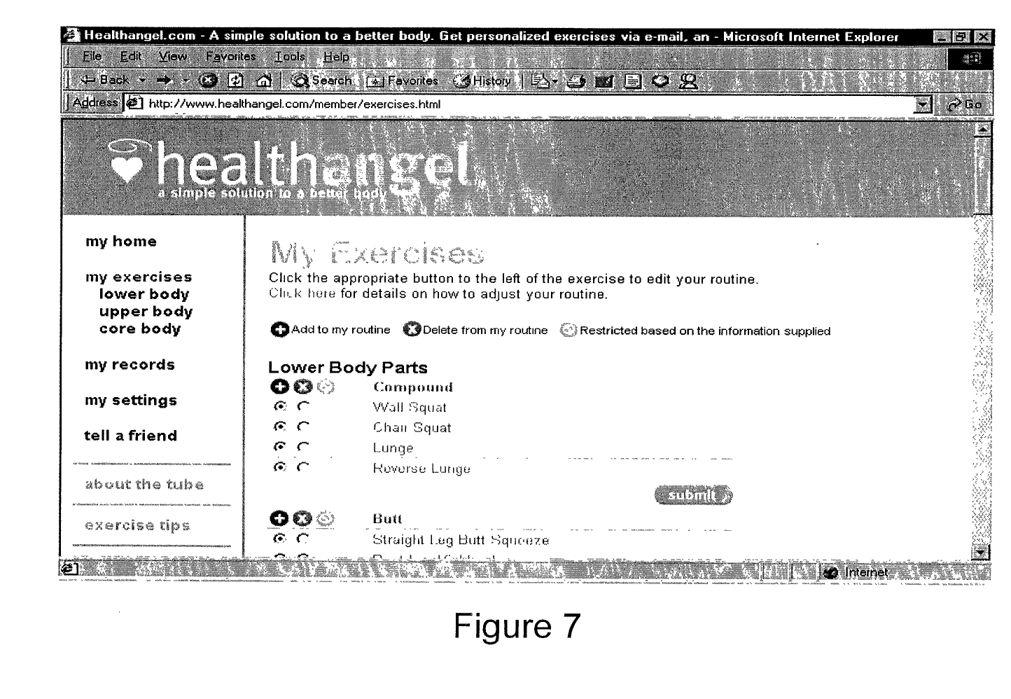

With reference to FIG. 7, an exemplary screen shot entitled “My Exercises” is depicted pursuant to which a user is permitted to select exercises from a predetermined menu of exercises for potential inclusion in the user's exercise regimen. Thus, as shown in FIG. 7, the user may designate an exercise in the “+” column, thereby adding such exercise to the user's routine, or in the “x” column, thereby deleting the exercise from the user's routine. The exercises are advantageously grouped by body region, e.g., lower body parts, upper body parts, etc.

Of note, certain exercises may not be available for selection/designation by a user, e.g., they may be assigned to the “cross out” column, because such exercise(s) are deemed inappropriate/unacceptable based on the information supplied by the user. Such information generally relates to the user's physical condition, limitations, and/or injuries. The system/method of the present disclosure advantageously includes criteria for blocking selection of specific exercise(s) based on such predetermined circumstances, thereby avoiding potential injury, discomfort or inability to perform with respect to such specific exercise(s).

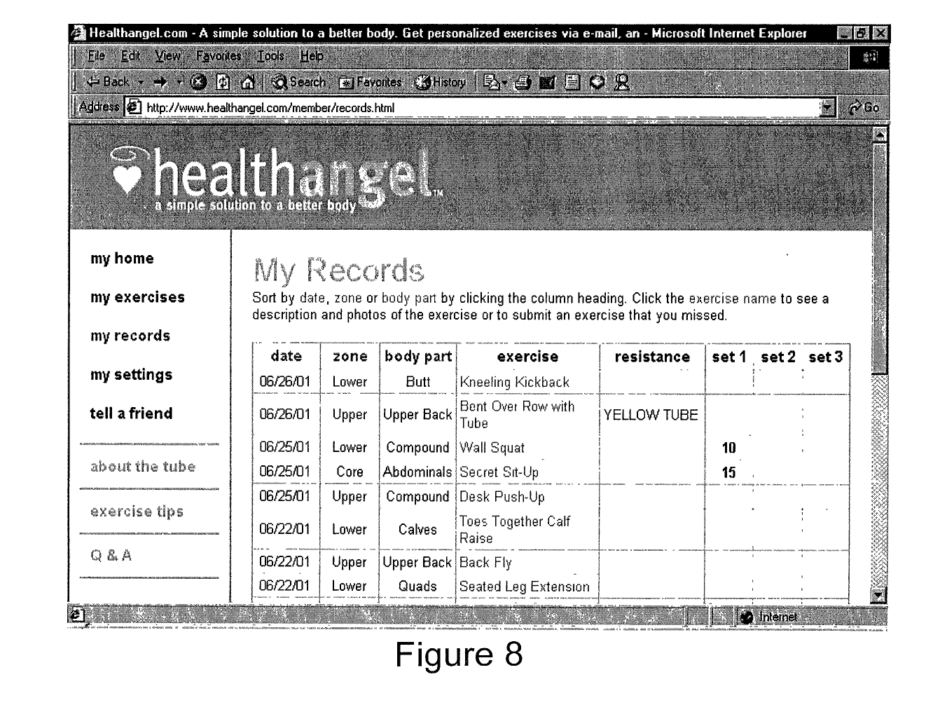

With reference to FIG. 8, an exemplary screen shot entitled “My Records” is depicted pursuant to which a user may monitor his/her performance pursuant to the method/system of the present disclosure. The “My Records” screen summarizes a user's performance with respect to prompted exercises over the course of such user's participation, reflecting relevant information associated with such exercise regimen. Thus, in the exemplary embodiment depicted in FIG. 8, the My Records screen includes information related to the date of the prompted exercise, the zone(s) and body part(s) primarily targeted by such exercises, the name of the exercise, the accessory items utilized to provide “resistance” according to the exercise (e.g., a tube), and the number of repetitions performed by the user within each exercise set. In preferred embodiments of the present disclosure, tracking information of the type set forth in FIG. 8 may be sorted in a variety of ways, as selected by the user, e.g., by date, body zone or body part.

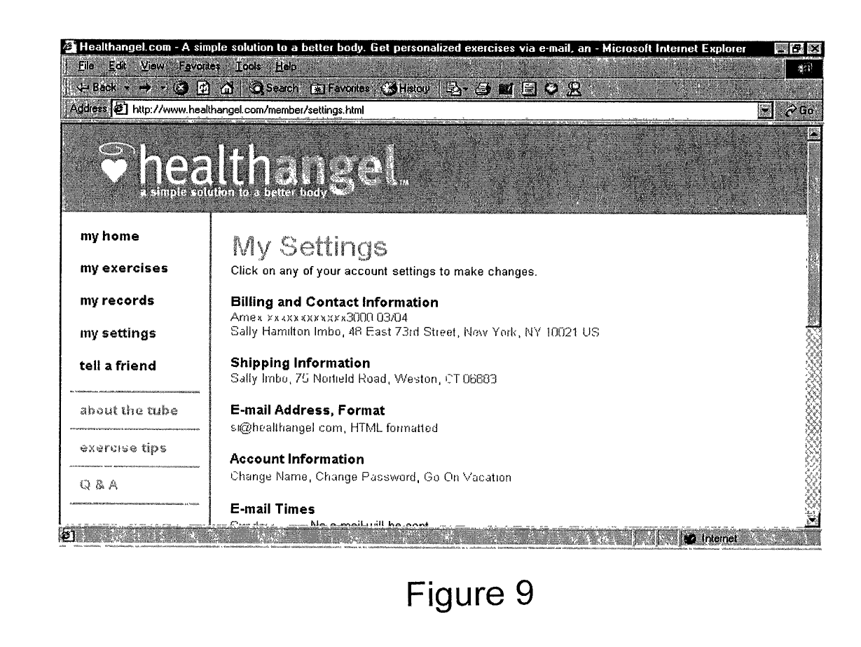

Turning to FIG. 9, an exemplary screen shot entitled “My Settings” is depicted according to the present disclosure. The “My Settings” screen allows users of the disclosed method/system to readily view and update relevant personal information concerning the user, e.g., billing and contact information, shipping information, email address, account information, email times, physical limitations/characteristics/objectives, times and locations for exercise completion, and the like. Of note, access to the various personalized aspects of the disclosed system, e.g., the My Exercises, My Records, and My Settings screens (and associated information), are restricted to the individual user, e.g., by way of appropriate password protection, and administrative personnel associated with providing the services described herein. Thus, according to preferred embodiments of the present disclosure, with the exception of appropriate administrative personnel, only the user and/or third parties authorized by the user (e.g., trainer, therapist, physician, spouse) may view personal information with respect to an individual user of the system/method.

With reference to FIGS. 10a-10h, a series of exemplary Membership Signup screens according to a preferred embodiment of the present disclosure are shown. With reference to FIG. 10a, the potential user is initially asked for certain basic personal information, e.g., name, e-mail address, desired password and password reminder, and desired e-mail format. Certain market research information may also be advantageously collected. The exemplary screens of FIGS. 10b to 10d provide the potential user with the opportunity to input additional personal information, namely, location for exercise breaks (FIG. 10b), preferred times for exercise breaks (FIG. 10c), and area of body focus as well as baseline fitness level (FIG. 10d). With particular reference to FIG. 10c, the user is permited to select the days and times at which he/she would prefer to be prompted to do his/her exercises. As shown in FIG. 10c, the exemplary system/method defaults to a Monday through Friday schedule, but accommodates individuals that desire to receive prompt(s) over the weekend and/or eliminate certain days of the week from exercise breaks. Of note, the potential user is asked to enter the current time at his/her location on the screen of FIG. 10b, thereby permitting the disclosed system/method to “synchronize watches” for purposes of future exercise prompts.

Also, with further reference to the exemplary screen of FIG. 10b, the exercise settings are divided into four categories: Home/Hotel; Private Office; Semi-Private Office; and Public Office. Although the four categories depicted in FIG. 10b capture a high percentage of potential registrants/users, additional categories are contemplated and may prove useful, e.g., restaurants, retail settings, delivery/travel positions, etc. Identification of an appropriate category by a registrant/user advantageously permits the disclosed system/method to provide setting-appropriate exercises to registrants/users.

The exemplary screen of FIG. 10e permits a potential user to input additional personal information, namely information related to exercise restrictions or limitations by body part/body region. This information related to exercise restrictions and/or limitations is advantageously used by the disclosed method/system to eliminate inappropriate exercises from a user's exercise regimen. The billing information collected in connection with the exemplary Billing Information screen of FIG. 10f ensures payment on behalf of the potential user.

The exemplary screens of FIGS. 10g and 10h provide the potential user with a summary of the personal information input to the system/method by way of the preceding screens, and confirmation/acknowledgement that the user has become a member/registered user, respectively. As noted previously, the personal information concerning location for exercise breaks (FIG. 10b), preferred times for exercise breaks (FIG. 10c), area of body focus/baseline fitness level (FIG. 10d), and exercise restrictions/limitations by body part/body region (FIG. 10e), provide guidance to the disclosed method/system in establishing an appropriate exercise regimen that is subsequently reflected on the user's My Settings screen. The exemplary screen of FIG. 10h provides additional information concerning utilization of the method/system, e.g., the importance of submitting exercises and the like.

Thus, in a preferred embodiment, the present disclosure advantageously provides a method/system wherein:

a) a registrant supplies information concerning his/her physical fitness condition and/or objectives to a server across a network;

b) the server receives the information from the registrant and, based on such information, selects an exercise regimen from a pre-populated exercise regimen database;

c) the server automatically transmits recommended exercise(s) to the registrant, e.g., by e-mail, at times and locations requested by the registrant; or the software automatically notifies the registrant of recommended exercise(s) and accesses those exercises based on times and locations requested by the registrant;

d) the registrant receives the transmissions/recommendations/notifications and, based on his/her performance of the recommended exercise(s), communicates his/her completion or non-completion thereof to the server, e.g., via e-mail or via communication from the software to the server; and

e) based on a registrant's performance of exercise(s), new recommended exercise(s) are selected for automatic recommendation to the registrant.

Beyond the detailed description of preferred embodiment(s) of the system/method of the present disclosure set forth hereinabove, which relates primarily to health fitness/wellness-related communications, the method/system of the present disclosure is contemplated for widespread communicative applications, e.g., wherein:

a) a registrant supplies information concerning his/her objectives to a server across a network;

b) the server receives the information from the registrant and, based on such information, selects an action from a pre-populated database;

c) the server automatically transmits recommended action(s) to the registrant, e.g., by e-mail, at intervals requested by the registrant; or the software automatically notifies the registrant of recommended action(s) based on intervals requested by the registrant;

d) the registrant receives the transmissions and, based on his/her performance of the recommended action(s), communicates his/her completion or non-completion thereof to the server, e.g., via e-mail; and

e) based on a registrant's performance of action(s), new recommended action(s) are selected for automatic recommendation to the registrant.

Additional functionality is contemplated for inclusion with the system/method of the present disclosure. For example, one or more animated characters may be utilized to convey, encourage and/or promote the recommended exercises. Advantageous utilization of graphics, video and/or sound may be used to facilitate and encourage performance of the recommended exercises. For example, streaming video technology (as is known in the art) may be utilized to deliver instructive information concerning performance of recommended exercises. To the extent audio instruction is provided to registrants, it is contemplated that the audio portions of the files will be mutable and, optionally, the audio content portion may be alternatively provided to registrants through subtitles.

For users of the software notification system, to ensure that registrants are operating with the most up-to-date instruction available, it is contemplated that appropriate signal(s) and/or message(s) will be provided to alert registrants that information has been updated/revised. Similarly, it is contemplated that an appropriate signaling technique may be employed to remind registrants that they have outstanding exercise(s) to perform. For example, it is contemplated that a glowing halo, audio screen tapping and/or snack break message may be delivered to a registrant's computer to draw his/her attention thereto.

It is further contemplated that “live chat” or another form of personalized customer service may be desirably provided for registrants, e.g., to address questions concerning the performance of an exercise. Such live chat would be provided according to known technologies over the Internet and/or World Wide Web. In addition, it is envisioned that the system/method of the present disclosure may advantageously communicate recommendations to users whose interests surpass or exceed the specific recommendations contained in the pre-populated databases, e.g., individuals who have “outgrown” the exercise regimens available through the system/method. In such case, for example, the system/method may recommend next level,(s) to such “graduates,” and may facilitate placement, e.g., act as a referral source to ancillary affiliations and memberships, for the benefit of all involved. It is further contemplated that bulletin boards may be advantageously hosted to facilitate communications between and among participants according to the present system/method. Bulletin boards may be advantageous in promoting health-related events, facilitating interaction between participants, e.g., as workout buddies, and/or diet/nutrition advice and information. Bulletin boards (and chat rooms) may be hosted globally for the system, or within specific companies or other entities participating therein.

In a further embodiment of the present disclosure, a method/system is provided that addresses both health fitness and nutritional needs of users. Indeed, health fitness and nutrition are closely related in achieving optimal health and wellness, and the disclosed method/system provides a unified approach to enhancing both health fitness and nutrition in the context of a user's day-to-day activities. According to a preferred embodiment of such dual purpose method/system, a user is advantageously offered a “goal setting” opportunity, i.e., an opportunity to define/articulate objective(s)/goal(s) as they relate to health fitness and/or nutrition. The user is also provided an opportunity to establish a starting level with respect to his/her health fitness and/or nutrition. Based on such goal setting and starting level, the disclosed method/system advantageously establishes the user's nutritional and fitness plans moving forward. In preferred embodiments of the disclosed method/system, users are provided with unlimited access to a tracking tool that charts progress in the areas of nutrition and exercise, e.g., as they relate to the user's body fat and/or weight.

With further reference to the health fitness and nutritional functionalities disclosed herein, based on the average caloric content that an individual's body bums at rest, functionality is advantageously incorporated into the disclosed method/system to define health fitness and nutritional steps required to reach a user's goal(s)/objective(s), e.g., a user's weight and/or body fat goals. Such functionality generally utilizes objective information related to an individual, e.g., an individual's starting weight and/or body fat, basal metabolic rate (“BMR”), i.e., the number of calories that an individual's body burns at rest each day, an individual's age, gender, weight, height, and the like, as well as a calendar for determining how long it will take to reach a user's goal(s)/objective(s), given specific expenditures of energy and intake of food. [Of note, tools providing BMR functionality are known, e.g., tools of the type found at http://www.global-fitness.com/BMR_calc.html]. Changing any of the variables associated with the aforementioned calculations will generally change the estimated point at which the user will arrive at his/her objective, e.g., at a desired weight (whether the user's goal relates to gaining or losing weight) and/or body fat.

For example, the disclosed method/system may receive information from a user that establishes that his/her weight loss goal is 5 pounds and, based on such information, calculates that the goal can be reached in 3 weeks. The disclosed method/system may further calculate, based on such information, that the user can accelerate the process of reaching his/her weight loss goal by adding 30 minutes of cardiovascular exercise three times a week and/or by reducing his/her caloric intake by 100 calories per day. The disclosed method/system may advantageously communicate such “acceleration” option to the user, e.g., via a computer network as disclosed herein. Likewise, the disclosed method/system may calculate, based on such information, that if a user eats an extra cookie each day, the date for reaching the weight loss goal will be postponed by an additional week.

A “Daily Food Intake and Kcal Tool” may also be provided that records the daily food intake of user(s) and “analyzes” intake of users. The tool is also advantageously adapted to calculate Basal Metabolic Rate, which represents the number of calories a user's body bums at rest in a day. BMR is calculated based on information that the user supplies to the disclosed method/system, including height, weight and age. The BMR tool generally bases the recommended daily kcal for a user on information that is collected from users, including special consideration for pregnant or lactating women, and on recommendations by the United States Food and Drug Administration. According to a preferred embodiment of the present disclosure, users input what they have eaten by selecting foods from a comprehensive list of foods, and then indicate the quantity of that food that they have consumed. Based on such user input, the tool calculates the percentage of the user's Recommended Daily Allowance (“RDA”) consumed, as well as the user's Kcal intake. The tool may also advantageously provide the actual RDA in one column, e.g., for comparison/evaluation purposes.

The “Daily Food Intake and Kcal Tool” generally calculates, tracks and charts Kcal Intake and nutritional values of foods on an ongoing basis, not just daily. The disclosed method/system advantageously analyzes such information on a periodic basis, e.g., daily, and also accumulates data over weeks and months. The tool is also generally capable of tracking ancillary information associated with calorie intake, e.g., the user's mood, the user's eating habits, i.e., time of day that the user is eating. Other long-term analysis is contemplated for inclusion in the tool, including analysis and recommendations associated with consistent nutritional deficiencies in certain areas.

Preferred methods/systems according to the present disclosure will also offer the option of creating a personal “list” that would contain foods that the user regularly eats, so that users won't have to go through the whole list to add regular items. The user will have the ability to augment his/her personal list with additional items from a comprehensive listing, as desired. Similarly, users will be able to delete foods from the personal list, should such foods become less frequently consumed by the user.

Preferred methods/systems according to the present disclosure may also offer a tool to track caloric expenditures, e.g., caloric expenditures associated with cardiovascular work prompted as disclosed herein, and incorporate such caloric expenditure information into the personalized record for such user maintained within a database according to the disclosed method/system. To facilitate such caloric expenditure calculation, it is contemplated that caloric expenditure values will be assigned to the exercises communicated to users in connection with the health fitness aspect of the disclosed method/system and, to the extent a user reports completion of such exercise(s), the method/system automatically records such caloric expenditures for such user.

According to preferred embodiments of the present disclosure, the disclosed tool is advantageously provided with functionalities/capabilities that make it very “smart” by including, inter alia., the resting heart rate and age of the user, which will allow the disclosed method/system to set target training zones for fat burning or increasing cardiovascular endurance. By obtaining an indication of perceived rate of exertion for a user, the disclosed method/system can advantageously estimate the kcal burned for a given activity in a more personalized way, without necessarily requiring input as to the user's heart rate.

It is further contemplated according to the present disclosure that the disclosed method/system may make effective diet recommendations to users, including, e.g., reduced dairy and/or vegetarian menus. Examples of diet recommendations that may be effectively utilized according to the present disclosure are set forth in the text entitled “Chris Imbo's Peak 10 Fitness,” by Chris and Sally Imbo, The Berkley Publishing Group, 1996, the contents of which are hereby incorporated by reference.

In addition, it is contemplated according to preferred embodiments of the present disclosure that a calculator may be provided that includes functionality allowing users to enter daily caloric value(s). Users may they pick and choose from pre-designed menus to put together a meal plan for the day/week that adds up to their desired caloric intake. In preferred embodiments of the present disclosure, the calculator may be effectively incorporated with the analysis tool so that certain aspects may function together and/or operate interchangeably.

Thus, according to the present disclosure, an integrated communicative tool for addressing, on a personalized basis, a user's nutritional and health fitness needs/objectives may be provided. The disclosed method/system offers significant flexibility and functionality to users that permits easy and effective interactivity to identify, monitor and achieve goals and objectives.

While the present disclosure contains a description of the method/system of the present disclosure with reference to various specific embodiments, those skilled in the art will readily appreciate that various modifications, changes and enhancements may be made thereto without departing from the spirit or scope thereof.

1. A method for facilitating a user activity, comprising:
a) receiving personalized information from a user related to a user activity, said personalized information including a user address and at least one communication guideline;
b) automatically transmitting a periodic message to said user consistent with said at least one communication guideline, said periodic message intended to cause at least one action by said user related to said user activity; and
c) receiving responsive information from said user in response to said periodic message related to status of said at least one action.

2. A method according to claim 1, wherein said personalized information and responsive information are received, and said periodic message is automatically transmitted, across a computer network.

3. A method according to claim 1, wherein said user activity relates to health fitness and wherein said personalized information further includes information related to a health condition of said user.

4. A method according to claim 1, wherein said user activity relates to nutritional consumption.

5. A method according to claim 1, wherein said user activity is an activity selected from the group consisting of: staying in touch with associates, sports training, investing, saving, maintaining possessions, repairing possessions, continuing education, and undertaking preventative medicine measures.

6. A method according to claim 1, wherein said user address is an email address and said periodic message is automatically transmitted to said user by electronic mail.

7. A method according to claim 1, wherein said at least one communication guideline is related to desired time for receipt of said periodic message.

8. A method according to claim 1, wherein said personalized information is selected from a group consisting of health fitness objectives, work environment, physical limitations, physical restrictions, weight, height, age, base-line physical information, base-line cardiovascular information, cholesterol level, body fat, blood pressure, health fitness habits, and combinations thereof.

9. A method according to claim 1, wherein said periodic message is intended to cause said user to complete an exercise.

10. A method according to claim 9, wherein said periodic message provides a link to instructive information related to said exercise.

11. A method according to claim 1, further comprising providing said user with access to a predetermined exercise menu and receiving said user's exercise selections from said predetermined exercise menu.

12. A method according to claim 1, further comprising creating a record of said periodic message and said responsive information for subsequent access by said user.

13. A method according to claim 1, further comprising selecting said at least one action from a predetermined menu of actions for automatic transmission to said user.

14. A method according to claim 13, further comprising selecting a second action from a predetermined menu of actions for automatic transmission to said user.

15. A method according to claim 14, wherein said second action is selected from said predetermined menu of actions based on said responsive information received from said user with respect to said status of said at least one action.

16. A method according to claim 14, wherein said at least one action and said second action are exercises.

17. A system for for facilitating a user activity, comprising:
a memory for storing digital data; and
a processor in communication with the memory, wherein the processor is operative to:
a) receive personalized information from a user related to a user activity and store said personalized information in said memory, said personalized information including a user address and at least one communication guideline;
b) automatically transmit a periodic message to said user consistent with said at least one communication guideline stored in said memory, said periodic message intended to cause at least one action by said user related to said user activity; and
c) receive responsive information from said user in response to said periodic message related to status of said at least one action, and store said responsive information in said memory.

18. A system according to claim 17, wherein said at least one action is an exercise, and wherein said memory contains an exercise menu from which said processor selects said exercise for automatic transmission to said user.

19. A system according to claim 18, wherein said processor selects said exercise from said exercise menu based on said user's personalized information.

20. A system according to claim 17, wherein said processor is further operative to provide additional periodic messages to said user, said additional periodic messages intended to cause additional actions on the part of said user, said additional actions reflecting said status of said at least one action.
